(19) United States
(12) Patent Application Publication
(10) Pub. No.: US 2026/0194937 A1
(43) Pub. Date: Jul. 9, 2026

(54) ELASTIC MEMBER AND DISPLAY DEVICE COMPRISING SAME

(71) Applicant: LG INNOTEK CO., LTD., Seoul (KR)

(72) Inventor: Sung Won KANG, Seoul (KR)

(21) Appl. No.: 19/128,325

(22) PCT Filed: Oct. 25, 2023
(86) PCT No.: PCT/KR2023/016632

§ 371 Date: May 8, 2025

(30) Foreign Application Priority Data
Nov. 11, 2022 (KR) 10-2022-0150901

(51) Int. Cl. G06F 1/16

(52) U.S. Cl. CPC G06F 1/1681; G06F 1/1652

(57) ABSTRACT

An elastic member according to an embodiment is an elastic member including a first region and a second region, and wherein the elastic member is defined in a first direction, which is a width direction, and a second direction, which is a length direction, the first region is divided into a first-first region and a first-second region, the first-second region is connected to both ends of the first-first region facing each other in the second direction, the first-first region includes a plurality of first pattern parts including a plurality of first patterns, the plurality of first pattern parts include a first-first pattern part including a first hinge pattern having one side open to an outside of the elastic member and a first-second pattern part not including a first hinge pattern, the first-second region includes a plurality of second pattern parts including a plurality of second patterns, the plurality of second pattern parts include a second-first pattern part including a second hinge pattern having one side open to the outside of the elastic member, and a second-second pattern part not including a second hinge pattern, and an opening rate per unit area of the first-first region and an opening rate per unit area of the first-second region are different.

### TECHNICAL FIELD

An embodiment relates to an elastic member and a display device including the same.

### BACKGROUND ART

Recently, there is a demand for a display device that is easy to carry various applications. In addition, there is a need for a display device capable of displaying images on a large screen when portable. Accordingly, a flexible display device or a foldable display device is being used.

The display device is stored in a folded or partially bent form. In addition, the display device is used in an unfolded state when displaying images. This increases the image display region and makes it easier for the user to carry the display device.

The display device is repeated in a restoration process such as bending and then unfolding the display device again. Accordingly, the display device includes an elastic member that may be bent in one direction.

The elastic member is bent at a curvature within a set size range. When the elastic member is bent, stress occurs. A plurality of openings are formed in a folding region of the elastic member to reduce the stress.

A magnitude of stress of the elastic member varies depending on an area of the opening. Accordingly, a curvature size of the elastic member can also vary depending on an area of the opening.

Recently, there is a demand for display devices of various shapes. Accordingly, the elastic member must be bent in various shapes. However, if the openings formed in the folding region are provided with a uniform size, a shape of the folding region is limited.

Therefore, an elastic member with a new structure capable of solving the above problems is required.

### DISCLOSURE

### Technical Problem

An embodiment provides an elastic member capable of variously forming a shape of a folding region.

The embodiment provides an elastic member which may be easily manufactured with improved reliability.

### Technical Solution

An elastic member according to an embodiment is an elastic member including a first region and a second region, and wherein the elastic member is defined in a first direction, which is a width direction, and a second direction, which is a length direction, the first region is divided into a first-first region and a first-second region, the first-second region is connected to both ends of the first-first region facing each other in the second direction, the first-first region includes a plurality of first pattern parts including a plurality of first patterns, the plurality of first pattern parts include a first-first pattern part including a first hinge pattern having one side open to an outside of the elastic member and a first-second pattern part not including a first hinge pattern, the first-second region includes a plurality of second pattern parts including a plurality of second patterns, the plurality of second pattern parts include a second-first pattern part including a second hinge pattern having one side open to the outside of the elastic member, and a second-second pattern part not including a second hinge pattern, and an opening rate per unit area of the first-first region and an opening rate per unit area of the first-second region are different.

### Advantageous Effects

The elastic member according to the embodiment is folded into various shapes.

The elastic member includes a first-first region and a first-second region. In addition, the first-first region and the first-second region have different opening rates per unit area.

Accordingly, magnitudes of the stress applied to the first-first region and the stress applied to the first-second region are different.

Accordingly, the first-first region is folded to a first curvature size. In addition, the first-second region is folded to a second curvature size. That is, the first-first region and the first-second region are folded to different curvature sizes.

Accordingly, the elastic member has improved folding reliability and strength. In addition, a folding shape of the first region can be formed into various shapes. Therefore, the elastic member is applied to display devices having various shapes.

### DESCRIPTION OF DRAWINGS

FIG. 1 is a perspective view of a display device according to an embodiment.

FIG. 2 is a perspective view of an elastic member according to an embodiment.

FIG. 3 is a drawing for explaining a region of an elastic member according to an embodiment.

FIG. 4 is a top view of an elastic member according to a comparative example.

FIG. 5 is a side view of an elastic member according to a comparative example after folding.

FIG. 6 is a top view of a first region of an elastic member according to a first embodiment.

FIG. 7 (a) to (b) is a drawing illustrating a shape of an elastic member according to a first embodiment after folding.

FIG. 8 is a top view of a first region of an elastic member according to a second embodiment.

FIG. 9 (a) to (b) is a drawing illustrating a shape of an elastic member according to a second embodiment after folding.

FIG. 10 is a top view of a first region of an elastic member according to a third embodiment.

FIG. 11 (a) to (b) is a drawing illustrating a shape of an elastic member according to a third embodiment after folding.

FIG. 12 is a top view of a first region of an elastic member according to a fourth embodiment.

FIG. 13 (a) to (b) is a drawing illustrating a shape of an elastic member according to a fourth embodiment after folding.

FIGS. 14 and 15 are cross-sectional views of a folding support including an elastic member according to an embodiment.

FIG. 16 is a cross-sectional view of a display device including a flexible support according to an embodiment.

FIG. 17 is a drawing for explaining an application example of a display device according to an embodiment.

### BEST MODE

Hereinafter, embodiments will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and redisposed. In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

Further, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “contacted” to another element, it may include not only when the element is directly “connected” to, “coupled” to, or “contacted” to other elements, but also when the element is “connected”, “coupled”, or “contacted” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, an elastic member according to an embodiment, and a folding support and a display device including the same will be described with reference to the drawings.

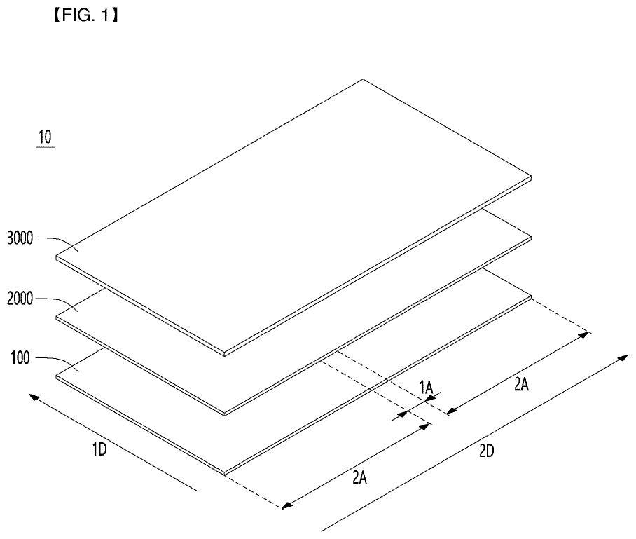

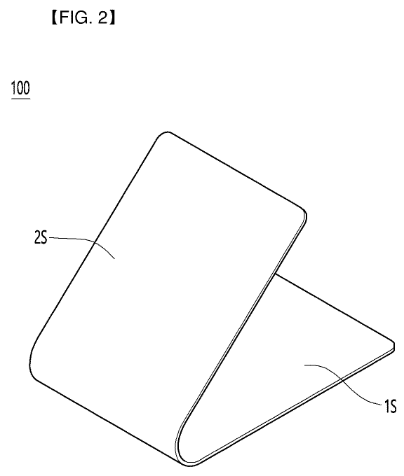

FIG. 1 is a perspective view of a display device according to an embodiment. FIG. 2 is a perspective view of an elastic member according to an embodiment.

Referring to FIG. 1, a display device 10 according to an embodiment includes an elastic member 100 and a panel disposed on the elastic member 100. The panel includes at least one of a display panel 2000 and a touch panel 3000.

The elastic member 100 supports the display panel 2000 and the touch panel 3000. The elastic member 100 may be a support substrate supporting the display panel 2000 and the touch panel 3000.

The touch panel 3000 and the display panel 2000 may be formed integrally. For example, the touch panel 3000 may be formed in an on-cell manner or an in-cell manner.

The elastic member 100 may include a metal material or a non-metal material. For example, the elastic member 100 may include a metal, a metal alloy, a plastic, a composite material (e.g., a carbon fiber reinforced plastic, a magnetic or conductive material, a glass fiber reinforced material, etc.), a ceramic, sapphire, or glass.

The elastic member 100 may be flexible. Alternatively, the elastic member 100 may be foldable. That is, the elastic member 100 may be bent in one direction. That is, the elastic member 100 may be a display substrate applied to a flexible display device or a foldable display device.

The elastic member 100 may be defined in a first direction 1D and a second direction 2D different from the first direction 1D. For example, the first direction 1D may be a same direction as a folding axis FAX direction of the elastic member 100. The second direction may be a direction perpendicular to the first direction.

One of the first direction 1D and the second direction 2D may be a width direction of the elastic member 100. The other one of the first direction 1D and the second direction 2D may be a length direction of the elastic member 100.

Hereinafter, the first direction 1D is defined as the width direction of the elastic member 100. The second direction 2D is defined as the length direction of the elastic member 100.

The elastic member 100 may include at least two regions. In detail, the elastic member 100 may include a first region 1A and a second region 2A.

The first region 1A is a region where the elastic member 100 is folded. In addition, the second region 2A is a region where the elastic member 100 is not folded. In detail, after the elastic member 100 is folded, the first region 1A has a curvature exceeding 0, and the second region 2A has a curvature of 0 or close to 0.

The display panel 2000 may be disposed on the elastic member 100.

The display panel 2000 may include a plurality of pixels including a switching thin film transistor, a driving thin film transistor, a capacitor, and an organic light emitting diode (OLED).

The display panel 2000 may include a substrate, a gate line disposed on the substrate, a data line intersecting the gate line in an insulated manner, and a common power line.

The substrate may include a material having flexible properties, such as a plastic film. The display panel 2000 is formed by arranging an organic light emitting diode and a pixel circuit on a flexible film.

The touch panel 3000 may be disposed on the display panel 2000. The display device has a touch function by the touch panel 3000. If the display device does not have a touch function, the touch panel may be omitted.

The touch panel 3000 may include a substrate and a touch electrode disposed on the substrate. The touch electrode is driven by a capacitive method or a resistive film method.

The substrate may include a material having flexible properties such as a plastic film. The touch panel 3000 is formed by arranging a touch electrode on a flexible film.

The touch panel 3000 and the display panel 2000 may be formed integrally. Therefore, a thickness of the display device is reduced.

The elastic member 100 and the display panel 2000 may have different sizes.

For example, an area of the elastic member 100 may be 90% to 110% of an area of the display panel 2000. In detail, the area of the elastic member 100 may be 95% to 105% of the area of the display panel 2000. More specifically, the area of the elastic member 100 may be 97% to 100% of the area of the display panel 2000.

If the area of the elastic member 100 is less than 90% of the area of the display panel 2000, a support force of the elastic member 100 is reduced. As a result, a curl may be formed in an unfolding region of the elastic member 100.

In addition, if the area of the elastic member 100 exceeds 110% of the area of the display panel 2000, the support force of the elastic member 100 is secured. However, a bezel region of the display device increases.

Meanwhile, although not shown in the drawing, the display device may further include a cover window. The display device is protected by the cover window.

The elastic member 100, the display panel 2000, and the touch panel 3000 are bonded to each other by an adhesive layer.

Referring to FIG. 2, the elastic member 100 is bent in one direction.

The elastic member 100 includes a first surface 1S and a second surface 2S opposite to the first surface 1S. The elastic member 100 may be bent so that the first surface 1S or the second surface 2S faces each other. That is, the elastic member 100 may be bent so that a surface on which the panels are disposed faces each other. Alternatively, the elastic member 100 may be bent so that an opposite surface of the surface on which the panels are disposed faces each other.

Conventionally, a folding shape of the elastic member was limited. An opening is formed in the folding region to reduce stress. The opening is formed with a uniform size and spacing, so that an opening rate per unit area of the folding region becomes same or similar. Therefore, since a curvature size of the folding region is limited, a folding shape of the elastic member is limited.

In addition, when the elastic member is bent to have a curvature size of 2 or more, there was a problem that deformation or cracks occurred in a boundary region where the curvature size changes.

Hereinafter, an elastic member that can solve the above problem is described.

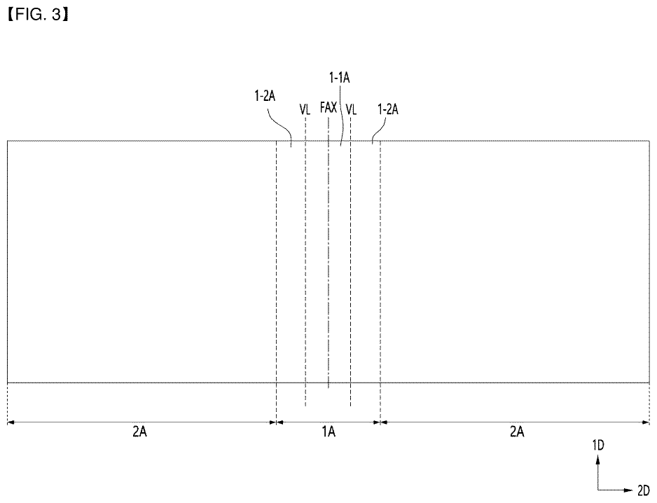

FIG. 3 is a drawing for explaining a region of an elastic member according to an embodiment. For convenience of explanation, FIG. 3 does not illustrate an opening pattern part formed in the elastic member.

Referring to FIG. 3, the elastic member 100 includes a first region 1A and a second region 2A. When the elastic member 100 is bent, the first region 1A is folded, and the second region 2A is not folded.

Sizes of the first region 1A and the second region 2A may be different from each other. In detail, the second region 2A may be larger than the first region 1A.

For example, an area of the first region 1A may be 1% to 30% of a total area of the elastic member 100. In detail, the area of the first region 1A may be 5% to 20% of the total area of the elastic member 100. More specifically, the area of the first region 1A may be 10% to 15% of the total area of the elastic member 100.

If the area of the first region 1A is less than 1% of the total area of the elastic member 100, When the folding and restoration of the elastic member is repeated, a crack may occur in a boundary region of the first region 1A and the second region 2A.

In addition, if the area of the first region 1A exceeds 30% of the total area of the elastic member 100, when folding the elastic member, a curl may be formed in the folding region of the display panel 2000.

The first region 1A corresponds to the folding region. That is, the first region 1A is a folding region.

In addition, the first region 1A may include a folding region and a boundary region. The boundary region is a region between the folding region and the unfolding region.

The first region 1A is divided into a plurality of regions. The first region 1A includes a first-first region 1-1A and a first-second region 1-2A. The first-first region 1-1A is disposed at a position corresponding to the folding axis FAX of the elastic member 100. In addition, the first-second region 1-2A is disposed at left and right sides of the first-first region 1-1A. That is, the first-second region 1-2A is disposed between the first-first region 1-1A and the second region 2A.

A virtual line (VL) is formed on the first region 1A. The first-first region 1-1A and the first-second region 1-2A are distinguished by the virtual line (VL).

The first-first region 1-1A and the first-second region 1-2A are defined as regions that are bent with different curvature sizes or curvature radii. For example, the first-first region 1-1A may be bent with a larger curvature or a smaller curvature radius than the first-second region 1-2A.

Alternatively, the first-first region 1-1A and the first-second region 1-2A are defined as regions that have different opening rates. The opening rate is an opening rate per unit area of a pattern part formed in the first region 1A. The opening rate per unit area can be defined as an opening rate of an area where at least 5 of the pattern parts exist.

For example, the opening rate per unit area of the first-first region 1-1A can be greater than the opening rate per unit area of the first-second region 1-2A. Alternatively, the opening rate per unit area of the first-second region 1-2A can be greater than the opening rate per unit area of the first-first region 1-1A.

Alternatively, the first-first region 1-1A and the first-second region 1-2A are defined as regions in which maximum lengths or a minimum lengths of pattern parts are different. For example, a minimum length of a pattern part of the first-first region 1-1A can be less than a minimum length of a pattern part of the first-second region 1-2A. Alternatively, a maximum length of a pattern part of the first-first region 1-1A may be greater than a maximum length of a pattern part of the first-second region 1-2A.

The elastic member 100 includes a first region divided into a plurality of regions. In addition, the plurality of regions are bent with different curvatures or curvature radii. Alternatively, the plurality of regions of the first region have different opening rates per unit area. Alternatively, maximum lengths or minimum lengths of the pattern parts of the plurality of regions of the first region are different.

Therefore, when the elastic member 100 is folded, the first region may have various shapes. In detail, the first region is formed into a shape having a curvature size of at least 2 or more. In addition, the plurality of regions of the first region may have different sizes and areas of the pattern parts depending on a size of the curvature or curvature radius.

Accordingly, the elastic member can form the shape of the folding region in various ways and prevent deformation due to stress in each region. Accordingly, the elastic member has design freedom and improved reliability.

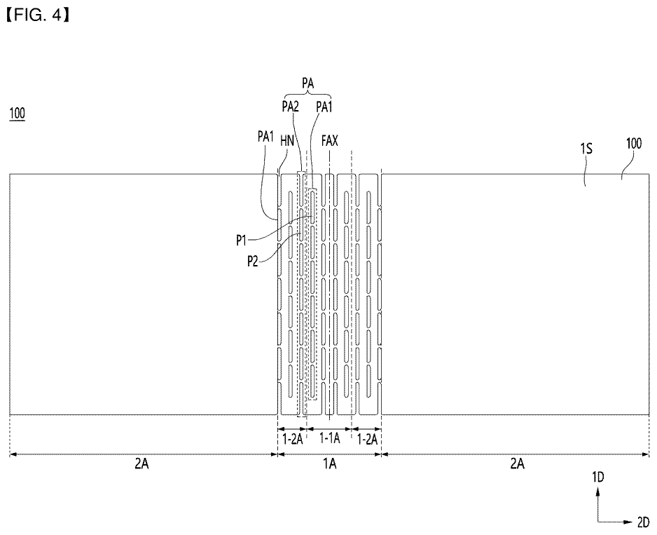

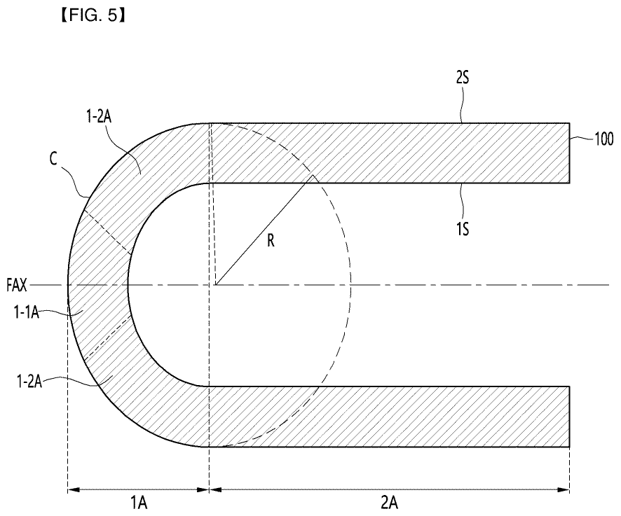

FIG. 4 is a top view of an elastic member according to a comparative example. FIG. 5 is a side view of an elastic member according to a comparative example after folding.

Referring to FIG. 4, the elastic member according to a comparative example includes a plurality of patterns disposed in the first region. The patterns may be formed in a hole shape that entirely penetrates the elastic member. Alternatively, the patterns may be formed in a groove shape that partially penetrates the elastic member.

The first region includes a first-first region 1-1A and a first-second region 1-2A. Patterns are disposed in each of the first-first region 1-1A and the first-second region 1-2A. For example, the first-first region 1-1A includes a first pattern part PA1. The first pattern part PA1 includes a first pattern P1. The first-second region 1-2A includes a second pattern part PA2. The second pattern part PA2 includes a second pattern P2.

The first pattern P1 and the second pattern P2 have a same or similar length. In addition, the first pattern P1 and the second pattern P2 have a same or similar spacing. That is, patterns of a same or similar length are disposed at a same or similar spacing in the first region 1A.

Accordingly, an opening rate per unit area of the first-first region 1-1A and an opening rate per unit area of the first-second region 1-2A may be same or similar. Accordingly, a maximum curvature size of the first-first region 1-1A and a maximum curvature size of the first-second region 1-2A may be same or similar.

For example, both the first-first region 1-1A and the first-second region 1-2A may be folded to a size of a curvature (C) less than or equal to a size of X or a curvature radius (R) greater than or equal to 1/X. In addition, if the first-first region 1-1A and the first-second region 1-2A are folded to a size of a curvature (C) greater than or equal to the size of X or a curvature radius (R) less than or equal to 1/X, the elastic member may undergo plastic deformation due to stress.

As shown in FIG. 5, the elastic member according to the comparative example is folded with one curvature (C) or curvature radius (R) size. That is, the first-first region 1-1A and the first-second region 1-2A are folded with a same curvature (C) or curvature radius (R) size.

Alternatively, the elastic member according to the comparative example is folded so that the first-first region 1-1A and the first-second region 1-2A have different curvatures (C) or curvature radius (R) sizes. However, the curvatures (C) and curvature radius (R) of the first-first region 1-1A and the first-second region 1-2A are limited. That is, the curvature is limited to X size or less. In addition, the curvature radius (R) is limited to 1/X or more.

Therefore, the elastic member according to the comparative example is limited in a folding shape or curvature size. Accordingly, the elastic member according to the comparative example is difficult to fold into various shapes. Therefore, it is difficult to apply to display devices of various shapes.

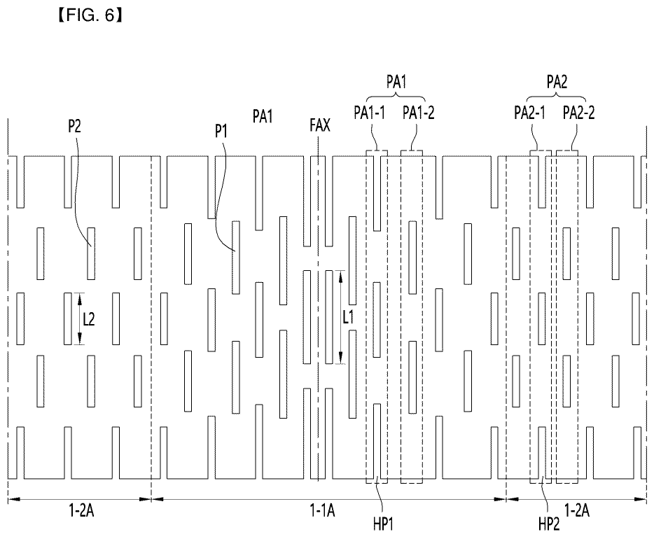

Hereinafter, an elastic member according to an embodiment will be described with reference to FIGS. 6 to 13.

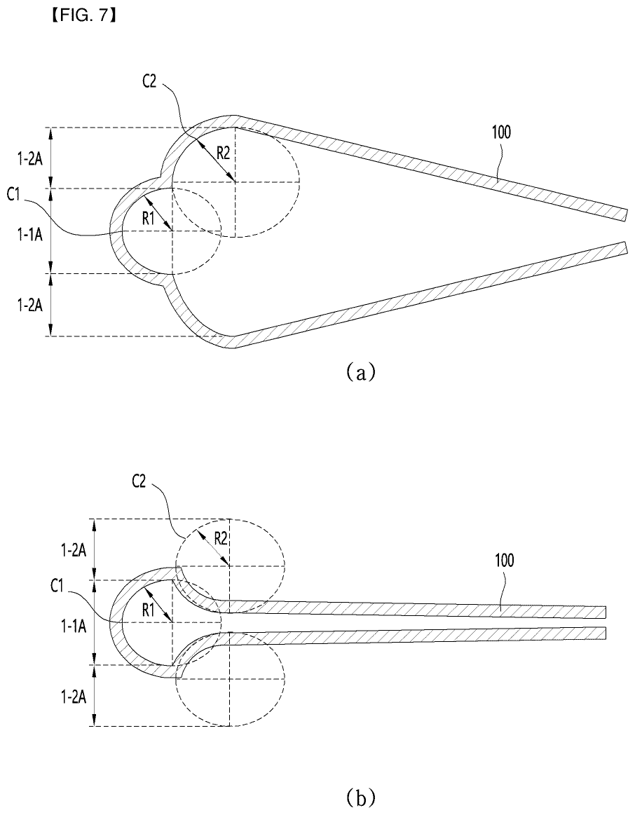

FIGS. 6 and 7 are drawings for explaining an elastic member according to a first embodiment.

Referring to FIG. 6, the first region 1A of the elastic member 100 according to the first embodiment is divided into a first-first region 1-1A and a first-second region 1-2A. The first-first region 1-1A is disposed at a position corresponding to the folding axis FAX of the elastic member. The first-second region 1-2A is connected to both ends of the first-first region 1-1A facing each other in the length direction of the elastic member.

The first-first region 1-1A and the first-second region 1-2A are bent with different curvature sizes. The first-first region 1-1A and the first-second region 1-2A can be divided by a pattern.

The first region can include a plurality of patterns. The patterns can be formed as holes or grooves.

The first-first region 1-1A includes a plurality of first pattern parts PA1. The first pattern part PA1 includes a plurality of first patterns P1. The first-second region 1-2A includes a plurality of second pattern parts PA2. The second pattern part PA2 includes a plurality of second patterns P2.

The first pattern part PA1 includes a first-first pattern part PA1-1 and a first-second pattern part PA1-2. The first-first pattern part PA1-1 includes a first hinge pattern HP1. The first hinge pattern HP1 is a pattern in which one side of the pattern is opened to an outside of the elastic member. In detail, at least two or more first patterns may be the first hinge pattern HP1. In addition, the first-second pattern part PA1-2 does not include the first hinge pattern HP1.

In addition, the second pattern part PA2 includes a second-first pattern part PA2-1 and a second-second pattern part PA2-2. The second-first pattern part PA2-1 includes a second hinge pattern HP2. The second hinge pattern HP2 is a pattern in which one side of the pattern is opened to the outside of the elastic member. In detail, at least two or more second patterns may be second hinge patterns HP2. In addition, the second-second pattern part P21-2 does not include the second hinge pattern HP2.

The first patterns P1 of one first pattern part PA1 are spaced apart in the first direction 1D. In addition, the plurality of first pattern parts PA1 are spaced apart in the second direction 2D.

The plurality of first pattern parts PA1 may include first patterns P1 having different sizes. For example, the plurality of first pattern parts PA1 may include first patterns P1 having different lengths. In detail, a length L1 of the first patterns P1 of the plurality of first pattern parts PA may decrease as they move away from a center of the first-first region 1-1A in the length direction of the elastic member. That is, the length L1 of the first pattern P1 of the plurality of first pattern parts PA1 may decrease as it moves away from a folding axis FAX.

In addition, the second pattern part PA2 may include a second pattern P2 having a same or similar size. For example, a length L2 of the second pattern P2 of the plurality of second pattern parts PA2 does not change as it moves away from a boundary region of the first-first region 1-1A and the first-second region 1-2A.

That is, a size of the first pattern P1 disposed in the first-first region 1-1A changes depending on positions. In addition, a size of the second pattern P2 disposed in the first-second region 1-2A does not change depending on positions.

In addition, a length of the first hinge pattern HP1 decreases as it moves away from a center of the first-first region 1-1A in the second direction 2D. In addition, a length of the second hinge pattern HP2 does not change as it moves away from a boundary of the first-first region 1-1A and the first-second region.

In addition, a maximum length of the first hinge pattern HP1 is greater than a maximum length of the second hinge pattern HP2. In addition, a minimum length of the first hinge pattern HP1 corresponds to a maximum length or minimum length of the second hinge pattern HP2.

The maximum length of the first pattern P1 may be greater than the maximum length of the second pattern P2. In addition, the minimum length of the first pattern P1 may be identical to or similar to the maximum length or minimum length of the second pattern P2. That is, a length L2 of the second pattern P2 may correspond to a minimum length of the first pattern P1.

Accordingly, an opening rate per unit area of the first-first region 1-1A and an opening rate per unit area of the first-second region 1-2A are different. In detail, the opening rate per unit area of the first-first region 1-1A may be greater than the opening rate per unit area of the first-second region 1-2A.

Therefore, the first-first region 1-1A and the first-second region 1-2A may be folded with different curvatures.

In detail, the first-first region 1-1A may be folded with a first curvature C1 less than or equal to a size of A. In addition, the first-second region 1-2A may be folded with a second curvature C2 less than or equal to a size of B. Since the opening rate per unit area of the first-first region 1-1A is greater than the opening rate per unit area of the first-second region 1-2A, the A may be greater than the B. Accordingly, the first-first region 1-1A may be folded with a greater curvature than the first-second region 1-2A. In addition, the first-second region 1-2A may be folded with a curvature that is the same as or smaller than the first-first region 1-1A.

For example, the elastic member according to the first embodiment may be folded into a folding shape as shown in FIG. 7. Referring to FIG. 7, curvature sizes of the first-first region 1-1A and the first-second region 1-2A may be different. In detail, a first curvature C1 of the first-first region 1-1A may be greater than a second curvature C2 of the first-second region 1-1A. That is, a first radius of curvature R1 of the first-first region 1-1A may be smaller than a second radius of curvature R2 of the first-second region 1-1A.

The elastic member according to the first embodiment may be folded into various shapes. In detail, the first-first region 1-1A and the first-second region 1-2A have different opening rates per unit area. Accordingly, magnitudes of the stress applied to the first-first region 1-1A and the stress applied to the first-second region 1-2A are different. Accordingly, the first-first region 1-1A can be folded to a first curvature size C1. In addition, the first-second region 1-2A can be folded to a second curvature size C2.

That is, in a range where a maximum size of the second curvature C2 satisfies a maximum size of a first curvature C1 or less, the first region can be folded into various shapes. That is, the first region can be folded so that the first-first region 1-1A and the first-second region 1-2A have different curvature sizes.

In addition, the size of the second pattern of the first-second region 1-2A does not change. Accordingly, the stress applied to the first-second region 1-2A is reduced. Accordingly, a size of the second curvature C2 of the first-second region 1-2A increases. That is, the second pattern is formed to have the same or similar size. Accordingly, the opening rate size per unit area of the first-second region 1-2A increases. Accordingly, a maximum curvature size of the first-second region increases.

In addition, the size of the first pattern of the first-first region 1-1A may decrease as it moves away from the folding axis. Accordingly, the folding reliability of the first-first region 1-1A and the strength of the elastic member are improved. That is, the stress of the first-first region 1-1A may be largest in a region adjacent to the folding axis. Accordingly, a size of the pattern is formed to be large in a region adjacent to the folding axis of the first-first region 1-1A. Accordingly, the elastic member can be prevented from being plastically deformed by the stress. In addition, the pattern of the first-first region 1-1A decreases as it moves away from the folding axis. Accordingly, the opening rate of the elastic member is reduced. Accordingly, the strength of the elastic member is improved.

Accordingly, the elastic member according to the first embodiment has improved folding reliability and strength. In addition, the first region has various folding shapes. Accordingly, the elastic member can be applied to display devices of various shapes.

Meanwhile, FIG. 6 illustrates that a length of the first pattern is changed in order to change a size of the first pattern. However, the embodiment is not limited thereto. That is, a width of the first pattern may be changed. Alternatively, the length and width of the first pattern may be changed.

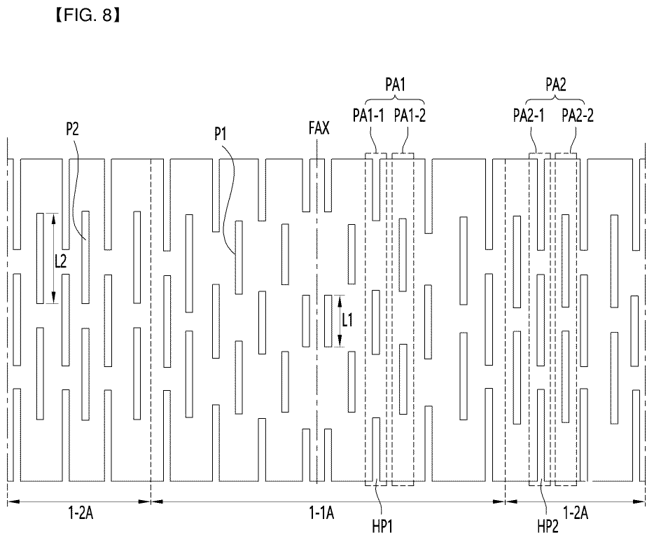

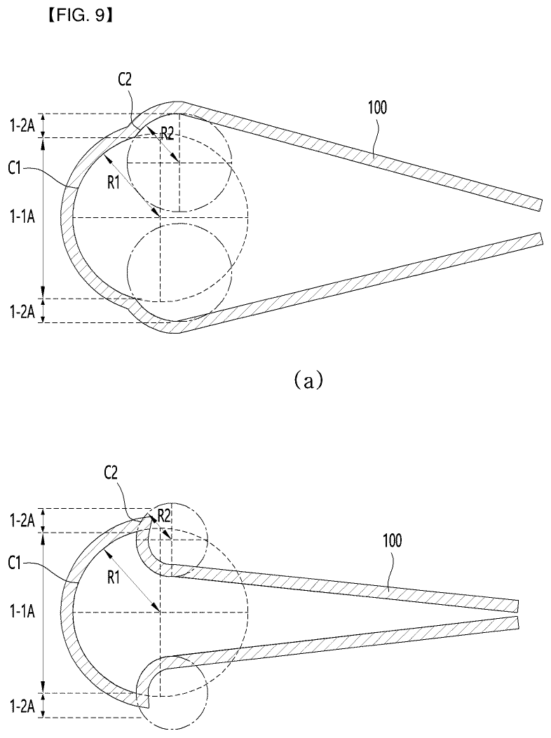

FIG. 8 and FIG. 9 are drawings for explaining an elastic member according to a second embodiment.

Referring to FIG. 8, the elastic member 100 according to a second embodiment includes a first region 1A and a second region 2A. The first region 1A is divided into a first-first region 1-1A and a first-second region 1-2A. The first-first region 1-1A is disposed at a position corresponding to the folding axis FAX of the elastic member. The first-second region 1-2A is connected to both ends of the first-first region 1-1A facing each other in the length direction 2D of the elastic member.

The first region may include a plurality of patterns. The patterns may be holes or grooves.

The first-first region 1-1A includes a plurality of first pattern parts PA1. The first pattern part PA1 includes a plurality of first patterns P1. The first-second region 1-2A includes a plurality of second pattern parts PA2. The second pattern part PA2 includes a plurality of second patterns P2.

The first patterns P1 of one first pattern part PA1 are spaced apart in the first direction 1D. The first pattern parts PA1 are spaced apart in the second direction 2D.

The first pattern part PA1 includes first patterns P1 having different sizes. For example, the plurality of first pattern parts PA1 may include first patterns P1 having different lengths. In detail, a length L1 of the first pattern P1 of the plurality of first pattern parts PA1 may increase as it moves away from a center of the first-first region 1-1A in the length direction of the elastic member. That is, a length L1 of the first pattern P1 of the plurality of first pattern parts PA1 may increase as it moves away from the folding axis FAX.

In addition, the first pattern part PA1 includes the first-first pattern part PA1-1 and the first-second pattern part PA1-2. The first-first pattern part PA1-1 includes a first hinge pattern HP1. The first hinge pattern HP1 is a pattern in which one side of the pattern is opened to the outside of the elastic member. In detail, at least two or more first patterns may be the first hinge pattern HP1. In addition, the first-second pattern part PA1-2 does not include the first hinge pattern HP1.

In addition, the second pattern part PA2 includes a second pattern P2 having a same or similar size. For example, a length L2 of the second pattern P2 of the plurality of second pattern parts PA2 does not change as it moves away from a boundary region of the first-first region 1-1A and the first-second region 1-2A.

That is, a size of the first pattern P1 in the first-first region 1-1A changes depending on positions. In addition, a size of the second pattern P2 in the first-second region 1-2A does not change depending on positions.

In addition, a length of the first hinge pattern HP1 increases as it moves away from the center of the first-first region 1-1A in the second direction 2D. In addition, a length of the second hinge pattern HP2 does not change as it moves away from a boundary of the first-first region 1-1A and the first-second region.

In addition, a minimum length of the first hinge pattern HP1 is smaller than a minimum length of the second hinge pattern HP2. In addition, a maximum length of the first hinge pattern HP1 corresponds to a maximum length or minimum length of the second hinge pattern HP2.

The minimum length of the first pattern P1 may be smaller than the minimum length of the second pattern P2. In addition, the maximum length of the first pattern P1 may be the same as or similar to the maximum length or minimum length of the second pattern P2. That is, the length of the second pattern P2 may correspond to the maximum length of the first pattern P1.

Accordingly, an opening rate per unit area of the first-first region 1-1A and an opening rate per unit area of the first-second region 1-2A are different. In detail, the opening rate per unit area of the first-second region 1-2A may be greater than the opening rate per unit area of the first-first region 1-1A.

Therefore, the first-first region 1-1A and the first-second region 1-2A may be folded with different curvatures.

In detail, the first-first region 1-1A can be folded with a first curvature C1 less than or equal to a size of A. In addition, the first-second region 1-2A can be folded with a second curvature C2 less than or equal to a size of B. At this time, since the opening rate per unit area of the first-second region 1-2A is greater than the opening rate per unit area of the first-first region 1-1A, the B can be greater than the A. Accordingly, the first-second region 1-2A can be folded with a curvature greater than that of the first-first region 1-1A. In addition, the first-first region 1-1A can be folded with a curvature equal to or less than that of the first-second region 1-2A.

For example, the elastic member according to the second embodiment can be folded with a folding shape as shown in FIG. 9. Referring to FIG. 9, the curvature sizes of the first-first region 1-1A and the first-second region 1-2A may be different. In detail, a first curvature C1 of the first-first region 1-1A may be smaller than a second curvature C2 of the first-second region 1-1A. That is, a first curvature radius R1 of the first-first region 1-1A may be larger than a second curvature radius R2 of the first-second region 1-1A.

The elastic member according to the second embodiment may be folded into various shapes. The first-first region 1-1A and the first-second region 1-2A have different opening rates per unit area. Accordingly, the magnitude of the stress applied to the first-first region 1-1A and the magnitude of the stress applied to the first-second region 1-2A are different. Therefore, the first-first region 1-1A can be folded to a first curvature C1 size. In addition, the first-second region 1-2A can be folded to a second curvature C2 size. That is, in a range where a maximum size of the first curvature C1 satisfies a maximum size of the second curvature C2 or less, the first region can be folded into various shapes. In addition, the first region can be folded so that the first-first region 1-1A and the first-second region 1-2A have different curvature sizes.

In addition, a size of the second pattern of the first-second region 1-2A does not change. Accordingly, the stress applied to the first-second region 1-2A decreases. Accordingly, a second curvature C2 size of the first-second region 1-2A increases. That is, since the second pattern is formed with the same or similar size, the opening rate size per unit area of the first-second region 1-2A increases. Accordingly, a maximum curvature size of the first-second region can increase.

In addition, a size of the first pattern of the first-first region 1-1A can increase as it moves away from the folding axis. Accordingly, the sizes of the first pattern and the second pattern in a boundary region of the first-first region 1-1A and the first-second region 1-2A become similar. Accordingly, a rapid stress change in the boundary region is prevented. Therefore, the boundary region of the elastic member can be prevented from being damaged.

Accordingly, the elastic member according to the second embodiment has improved folding reliability, and a folding shape of the first region varies. Therefore, the elastic member can be applied to display devices of various shapes.

FIG. 8 illustrates that the length of the first pattern is changed to change the size of the first pattern. The embodiment is not limited thereto. That is, the width of the first pattern can be changed. Alternatively, the length and width of the first pattern can be changed.

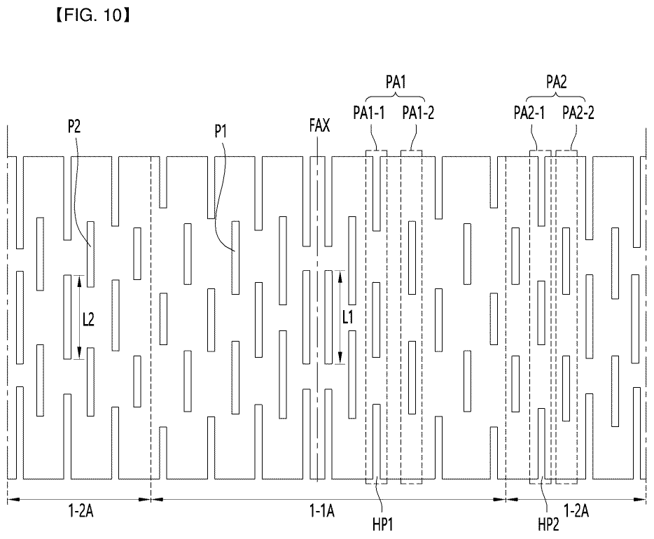

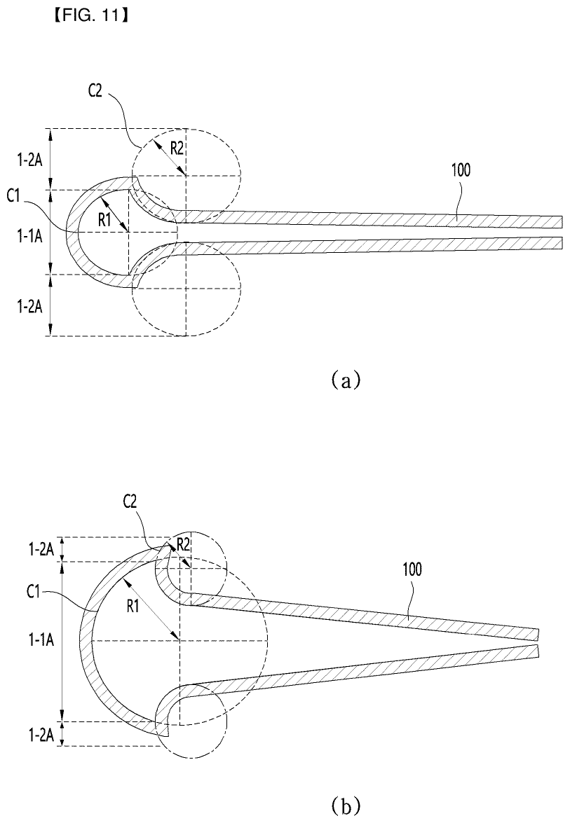

FIG. 10 and FIG. 11 are drawings for explaining an elastic member according to a third embodiment.

Referring to FIG. 10, the elastic member 100 according to the third embodiment can include a first region 1A and a second region 2A. The first region 1A can be divided into the first-first region 1-1A and the first-second region 1-2A. The first-first region 1-1A is disposed at a position corresponding to the folding axis FAX of the elastic member. The first-second region 1-2A is connected to both ends of the first-first region 1-1A facing each other in the length direction 2D of the elastic member.

The first region may include a plurality of patterns. The patterns may be formed as holes or grooves.

The first-first region 1-1A includes a plurality of first pattern parts PA1. The first pattern part PA1 includes a plurality of first patterns P1. The first-second region 1-2A includes a plurality of second pattern parts PA2. The second pattern part PA2 includes a plurality of second patterns P2. The first patterns P1 of one first pattern part PA1 are spaced apart in the first direction 1D. The plurality of first pattern parts PA1 are spaced apart in the second direction 2D.

The first pattern part PA1 may include first patterns P1 having different sizes. For example, the first pattern part PA1 may include first patterns P1 having different lengths. In detail, the length L1 of the first patterns P1 of the plurality of first pattern parts PA1 may decrease as they move away from the center of the first-first region 1-1A in the length direction of the elastic member. That is, the length L1 of the first patterns P1 of the plurality of first pattern parts PA1 may decrease as they move away from the folding axis FAX.

In addition, the first pattern part PA1 may include a first-first pattern part PA1-1 and a first-second pattern part PA1-2. The first-first pattern part PA1-1 includes a first hinge pattern HP1. The first hinge pattern HP1 is a pattern in which one side of the pattern is opened to the outside of the elastic member. In detail, at least two or more first patterns may be the first hinge pattern HP1. In addition, the first-second pattern part PA1-2 does not include the first hinge pattern HP1.

In addition, the second pattern part PA2 may include a second-first pattern part PA2-1 and a second-second pattern part PA2-2. The second-first pattern part PA2-1 includes a second hinge pattern HP2. The second hinge pattern HP2 is a pattern in which one side of the pattern is opened to the outside of the elastic member. In detail, at least two or more second patterns may be second hinge patterns HP2. In addition, the second-second pattern part P21-2 does not include the second hinge pattern HP2.

In addition, the second pattern part PA2 may include second patterns P2 having different sizes. For example, the second pattern part PA2 may include second patterns P2 having different lengths. In detail, the length L2 of the second patterns P2 of the plurality of second pattern parts PA2 may increase as they move away from the boundary region of the first-first region 1-1A and the first-second region 1-2A in the length direction of the elastic member. That is, the length L2 of the second patterns P2 of the plurality of second pattern parts PA2 may increase as they move away from the folding axis FAX.

That is, the first pattern P1 disposed in the first-first region 1-1A changes in size depending on the positions. In addition, the second pattern P2 disposed in the first-second region 1-2A changes in size depending on the positions.

In addition, the length of the first hinge pattern HP1 decreases as it moves away from a center of the first-first region 1-1A in the second direction 2D. In addition, the length of the second hinge pattern HP2 increases as it moves away from a boundary of the first-first region 1-1A and the first-second region.

In addition, a minimum length of the first hinge pattern HP1 is smaller than a minimum length of the second hinge pattern HP2, and in addition, a maximum length of the first hinge pattern HP1 is larger than a minimum length of the second hinge pattern HP2. In addition, a maximum length of the first hinge pattern HP1 corresponds to a maximum length of the second hinge pattern HP2.

The minimum length of the first pattern P1 may be the same as or similar to the minimum length of the second pattern P2. That is, the minimum length of the first pattern P1 may correspond to the minimum length of the second pattern P2. In addition, the maximum length of the first pattern P1 may be different from the maximum length of the second pattern P2.

Accordingly, an opening rate per unit area of the first-first region 1-1A and an opening rate per unit area of the first-second region 1-2A may be different. For example, a difference between the maximum length and the minimum length of the first pattern P1 may be different from a difference between the maximum length and the minimum length of the second pattern P2. In detail, if the difference between the maximum length and the minimum length of the first pattern P1 is greater than the difference between the maximum length and the minimum length of the second pattern P2, the opening rate per unit area of the first-first region 1-1A may be greater than the opening rate per unit area of the first-second region 1-2A. Alternatively, if the difference between the maximum length and the minimum length of the first pattern P1 is smaller than the difference between the maximum length and the minimum length of the second pattern P2, the opening rate per unit area of the first-first region 1-1A may be less than the opening rate per unit area of the first-second region 1-2A.

Therefore, the first-first region 1-1A and the first-second region 1-2A may be folded with different curvatures.

In detail, the first-first region 1-1A can be folded with a first curvature C1 less than or equal to the size of A. In addition, the first-second region 1-2A can be folded with a second curvature C2 less than or equal to the size of B. At this time, when the opening rate per unit area of the first-first region 1-1A is greater than the opening rate per unit area of the first-second region 1-2A, A can be greater than B. Accordingly, the first-first region 1-1A can be folded with a curvature greater than that of the first-second region 1-2A.

In addition, the first-second region 1-2A can be folded with a curvature equal to or less than that of the first-first region 1-1A. Alternatively, if the opening rate per unit area of the first-second region 1-2A is greater than the opening rate per unit area of the first-first region 1-1A, the B may be greater than the A. Accordingly, the first-second region 1-2A may be folded with a curvature greater than that of the first-first region 1-1A. In addition, the first-first region 1-1A may be folded with a curvature that is the same as or smaller than the first-second region 1-2A.

As an example, the elastic member according to the third embodiment may be folded into a folding shape as in FIG. 11. Referring to (a) of FIG. 11, the curvature sizes of the first-first region 1-1A and the first-second region 1-2A may be different. In detail, the first curvature C1 of the first-first region 1-1A may be larger than the second curvature C2 of the first-second region 1-1A. That is, the first curvature radius R1 of the first-first region 1-1A may be smaller than the second curvature radius R2 of the first-second region 1-1A.

Alternatively, referring to (b) of FIG. 11, the curvature sizes of the first-first region 1-1A and the first-second region 1-2A may be different. In detail, the first curvature C1 of the first-first region 1-1A may be smaller than the second curvature C2 of the first-second region 1-1A. That is, the first radius of curvature R1 of the first-first region 1-1A may be larger than the second radius of curvature R2 of the first-second region 1-1A.

The elastic member according to the third embodiment may be folded into various shapes. The first-first region 1-1A and the first-second region 1-2A may control the change in length of the pattern disposed in the first-first region 1-1A and the first-second region 1-2A according to a desired folding shape. For example, when a shape in which the curvature of the first-first region 1-1A is larger than the curvature of the first-second region 1-2A is required, a difference between the maximum length and the minimum length of the first pattern P1 is formed to be larger than a difference between the maximum length and the minimum length of the second pattern P2. By this, the opening rate per unit area of the first-first region 1-1A can be made larger than the opening rate per unit area of the first-second region 1-2A.

Alternatively, when a shape in which the curvature of the first-second region 1-2A is larger than the curvature of the first-first region 1-1A is required, the difference between the maximum length and the minimum length of the first pattern P1 is formed smaller than the difference between the maximum length and the minimum length of the second pattern P2. By this, the opening rate per unit area of the first-second region 1-2A can be made larger than the opening rate per unit area of the first-first region 1-1A.

Therefore, the elastic member according to the third embodiment forms the sizes of the first pattern and the second pattern differently at each position. In addition, the maximum and minimum lengths of the first pattern and the second pattern are controlled according to the size of the curvature required in the first-first region 1-1A and the first-second region 1-2A. Therefore, the first-first region 1-1A and the first-second region 1-2A can be folded into various shapes having different curvature sizes, and plastic deformation of the elastic member can be prevented.

Accordingly, the elastic member according to the third embodiment has improved folding reliability and can form various folding shapes of the first region. Therefore, the elastic member can be applied to display devices of various shapes.

Meanwhile, FIG. 10 illustrates that the lengths of the first pattern and the second pattern are changed in order to change the sizes of the first pattern and the second pattern. However, the embodiment is not limited thereto. That is, the widths of the first pattern and the second pattern can be changed. Alternatively, both the length and width of the first pattern and the second pattern can be changed.

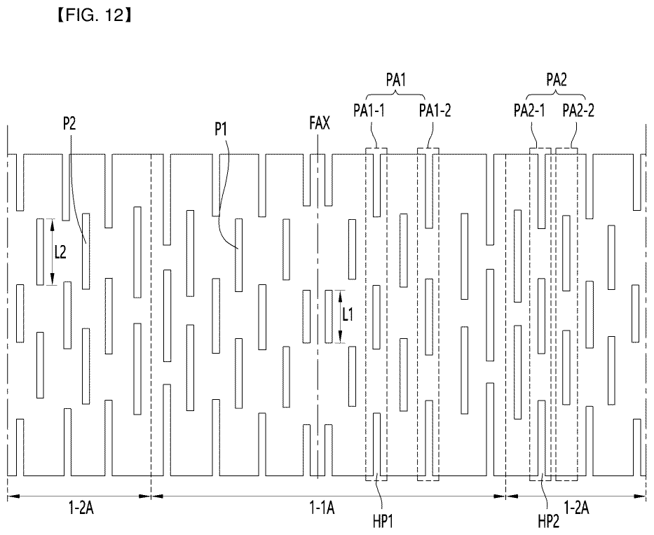

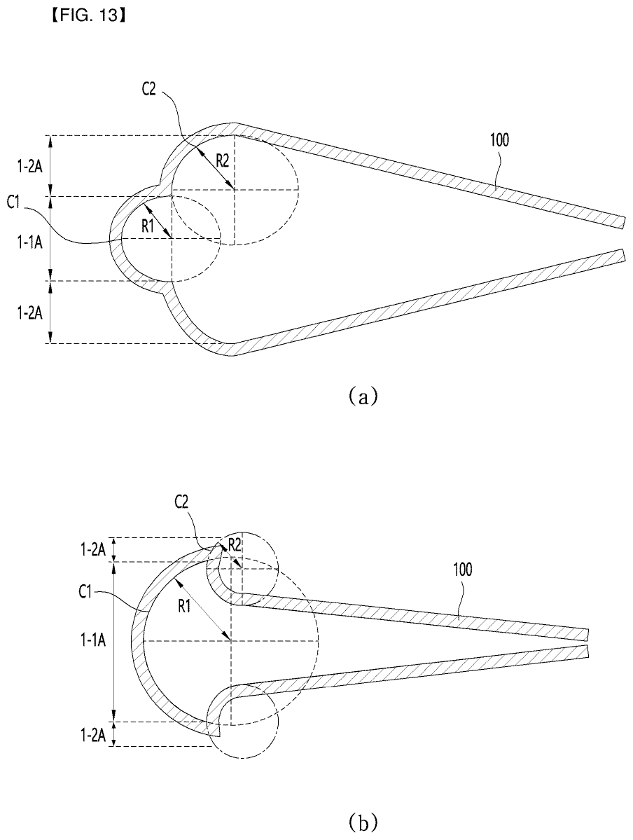

FIGS. 12 and 13 are drawings for explaining an elastic member according to a fourth embodiment.

Referring to FIG. 12, the elastic member 100 according to the fourth embodiment may include a first region 1A and a second region 2A. The first region 1A may be divided into a first-first region 1-1A and a first-second region 1-2A. The first-first region 1-1A is disposed at a position corresponding to the folding axis FAX of the elastic member. The first-second region 1-2A is connected to both ends of the first-first region 1-1A facing each other in the length direction 2D of the elastic member.

The first region may include a plurality of patterns. The patterns may be formed as holes or grooves.

In detail, the first-first region 1-1A includes a first pattern part PA1. The first pattern part PA1 includes a first pattern P1. The first-second region 1-2A may include a second pattern part PA2. The second pattern part PA2 includes a second pattern P2.

The first pattern part PA1 may include first patterns P1 having different sizes. For example, the first pattern part PA1 may include first patterns P1 having different lengths. In detail, the length L1 of the first patterns P1 of the plurality of first pattern parts PA1 may increase as they move away from the center of the first-first region 1-1A in the length direction of the elastic member. That is, the length L1 of the first patterns P1 of the plurality of first pattern parts PA1 may increase as they move away from the folding axis FAX.

In addition, the first pattern part PA1 may include a first-first pattern part PA1-1 and a first-second pattern part PA1-2. The first-first pattern part PA1-1 includes a first hinge pattern HP1. The first hinge pattern HP1 is a pattern in which one side of the pattern is open to the outside of the elastic member. In detail, at least two or more first patterns may be the first hinge patterns HP1. In addition, the first-second pattern part PA1-2 does not include the first hinge pattern HP1.

In addition, the second pattern part PA2 may include a second-first pattern part PA2-1 and a second-second pattern part PA2-2. The second-first pattern part PA2-1 includes the second hinge pattern HP2. The second hinge pattern HP2 is a pattern in which one side of the pattern is open to the outside of the elastic member. In detail, at least two or more second patterns may be second hinge patterns HP2. In addition, the second-second pattern part P21-2 does not include the second hinge pattern HP2.

In addition, the second pattern part PA2 may include second patterns P2 having different sizes. For example, the second pattern part PA2 may include second patterns P2 having different lengths. In detail, the length L2 of the second patterns P2 of the plurality of second pattern parts PA2 may decrease as they move away from a boundary region of the first-first region 1-1A and the first-second region 1-2A in the length direction of the elastic member. That is, the length L2 of the second pattern P2 of the plurality of second pattern parts PA2 can decrease as it moves away from the folding axis FAX.

That is, the size of the first pattern P1 on the first-first region 1-1A changes depending on the position. In addition, the size of the second pattern P2 on the first-second region 1-2A changes depending on the position.

In addition, the length of the first hinge pattern HP1 increases as it moves away from the center of the first-first region 1-1A in the second direction 2D. In addition, the length of the second hinge pattern HP2 decreases as it moves away from the boundary between the first-first region 1-1A and the first-second region.

In addition, a maximum length of the first hinge pattern HP1 is greater than a maximum length of the second hinge pattern HP2. In addition, a minimum length of the first hinge pattern HP1 corresponds to a minimum length of the second hinge pattern HP2.

A maximum length of the first pattern P1 may be same as or similar to a maximum length of the second pattern P2. That is, a maximum length of the first pattern P1 may correspond to a maximum length of the second pattern P2. In addition, the minimum length of the first pattern P1 may be different from the minimum length of the second pattern P2.

Accordingly, an opening rate per unit area of the first-first region 1-1A and an opening rate per unit area of the first-second region 1-2A may be different. For example, if the difference between the maximum length and the minimum length of the first pattern P1 is greater than the difference between the maximum length and the minimum length of the second pattern P2, the opening rate per unit area of the first-first region 1-1A may be smaller than the opening rate per unit area of the first-second region 1-2A. Alternatively, if the difference between the maximum length and the minimum length of the first pattern P1 is smaller than the difference between the maximum length and the minimum length of the second pattern P2, the opening rate per unit area of the first-first region 1-1A may be larger than the opening rate per unit area of the first-second region 1-2A.

Therefore, the first-first region 1-1A and the first-second region 1-2A may be folded with different curvatures.

In detail, the first-first region 1-1A can be folded with a first curvature C1 less than or equal to a size of A, and the first-second region 1-2A can be folded with a second curvature C2 less than or equal to a size of B. At this time, if the opening rate per unit area of the first-first region 1-1A is greater than the opening rate per unit area of the first-second region 1-2A, A can be greater than B. Accordingly, the first-first region 1-1A can be folded with a greater curvature than the first-second region 1-2A.

In addition, the first-second region 1-2A can be folded with a curvature that is the same as or less than the first-first region 1-1A. Alternatively, if the opening rate per unit area of the first-second region 1-2A is greater than the opening rate per unit area of the first-first region 1-1A, the B may be greater than the A. Accordingly, the first-second region 1-2A may be folded with a greater curvature than the first-first region 1-1A. In addition, the first-first region 1-1A may be folded with a curvature that is the same as or smaller than the first-second region 1-2A.

As an example, the elastic member according to the fourth embodiment may be folded into a folding shape as in FIG. 13. Referring to (a) of FIG. 13, the curvature sizes of the first-first region 1-1A and the first-second region 1-2A may be different. In detail, the first curvature C1 of the first-first region 1-1A may be greater than the second curvature C2 of the first-second region 1-1A. That is, the first radius of curvature R1 of the first-first region 1-1A may be smaller than the second radius of curvature R2 of the first-second region 1-1A.

Alternatively, referring to (b) of FIG. 13, the curvature sizes of the first-first region 1-1A and the first-second region 1-2A may be different. In detail, the first curvature C1 of the first-first region 1-1A may be smaller than the second curvature C2 of the first-second region 1-1A. That is, the first curvature radius R1 of the first-first region 1-1A may be larger than the second curvature radius R2 of the first-second region 1-1A.

The elastic member according to the fourth embodiment may be folded into various shapes. The first-first region 1-1A and the first-second region 1-2A can control the change in the length of the pattern disposed in the first-first region 1-1A and the first-second region 1-2A according to the desired folding shape. For example, if a shape in which the curvature of the first-first region 1-1A is greater than the curvature of the first-second region 1-2A is desired, the difference between the maximum length and the minimum length of the first pattern P1 is formed to be smaller than the difference between the maximum length and the minimum length of the second pattern P2. As a result, the opening rate per unit area of the first-first region 1-1A can be made greater than the opening rate per unit area of the first-second region 1-2A.

Alternatively, if a shape in which the curvature of the first-second region 1-2A is greater than the curvature of the first-first region 1-1A is desired, the difference between the maximum length and the minimum length of the first pattern P1 is formed to be greater than the difference between the maximum length and the minimum length of the second pattern P2. As a result, the opening rate per unit area of the first-second region 1-2A can be made greater than the opening rate per unit area of the first-first region 1-1A.

Therefore, the elastic member according to the fourth embodiment forms the sizes of the first pattern and the second pattern differently at each position. In addition, the maximum length and the minimum length of the first pattern and the second pattern are controlled according to the size of the curvature required in the first-first region 1-1A and the first-second region 1-2A. Accordingly, the first-first region 1-1A and the first-second region 1-2A can be folded into various shapes having different curvatures, and plastic deformation of the elastic member can be prevented.

In addition, the length of the second pattern P2 of the first-second region 1-2A adjacent to the second region 2A can decrease as it moves away from the folding axis. Accordingly, the pattern can be prevented from being recognized in the boundary region of the first-second region 1-2A and the second region 2A. In addition, a process of forming a separate pattern in the second region 2A to prevent recognition of the pattern is not required. Therefore, the overall strength of the elastic member can be improved, and process efficiency can be improved.

Accordingly, the elastic member according to the fourth embodiment has improved folding reliability, and the strength of the elastic member is improved. In addition, since the folding shape of the first region is formed in various ways, the elastic member can be applied to display devices of various shapes.

Meanwhile, in FIG. 12, the length of the first pattern and the second pattern is shown to be changed in order to change the size of the first pattern and the second pattern. However, the embodiment is not limited thereto. That is, the width of the first pattern and the second pattern can be changed. Alternatively, both the length and the width of the first pattern and the second pattern can be changed.

Meanwhile, in the description of the first to fourth embodiments, it was described that the pattern is formed only in the first region. However, the embodiment is not limited thereto. In detail, in at least one embodiment, the pattern can also be formed in the second region. The pattern disposed in the second region can decrease in size as it moves away from the folding axis in the second direction. Accordingly, since the pattern is prevented from being recognized in the boundary region of the first region and the second region, the elastic member has improved visibility.

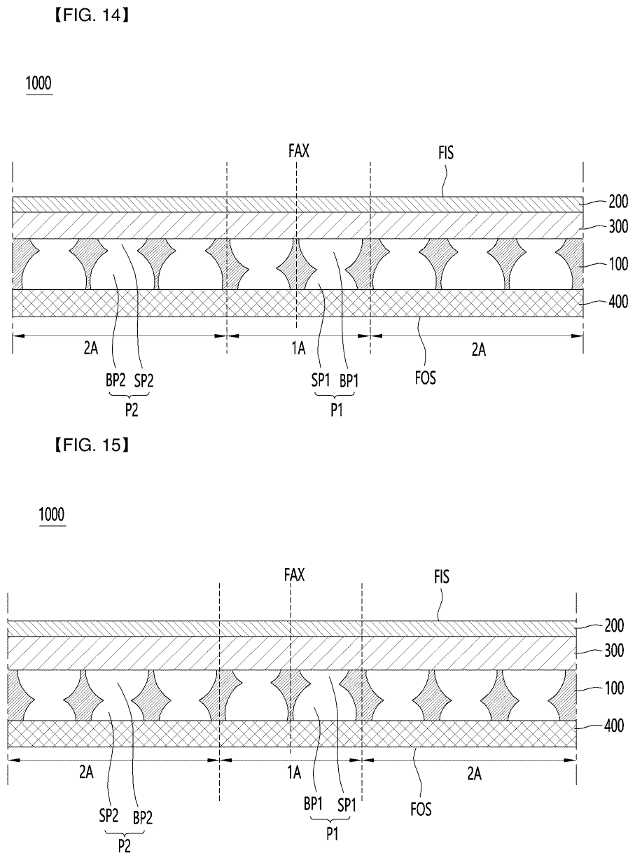

Hereinafter, with reference to FIGS. 14 and 15, a folding support including an elastic member according to the above-described embodiment will be described.

Referring to FIGS. 14 and 15, the folding support 1000 may include an elastic member 100, a flattening layer 200, an adhesive layer 300, and a protective layer 400.

The flattening layer 200 flattens a surface of the elastic member 100. The elastic member 100 includes a plurality of pattern parts in a shape of holes or grooves.

The surface of the elastic member 100 is not flat due to the pattern parts. Accordingly, when a panel or the like is directly adhered to the elastic member 100, the adhesive strength between the elastic member 100 and the panel may decrease.

Accordingly, the flattening layer 200 is disposed on the elastic member 100. Accordingly, an adhesive surface of the elastic member 100 becomes flat.

The flattening layer 200 may include a metal or a non-metal. In detail, the flattening layer 200 may include a metal or a plastic.

The adhesive layer 300 may be disposed between the elastic member 100 and the flattening layer 200. The elastic member 100 and the flattening layer 200 are adhered by the adhesive layer 300.

For example, the adhesive layer 300 may include a pressure sensitive adhesive (PSA). However, the embodiment is not limited thereto.

The protective layer 400 is disposed under the elastic member 100.

The protective layer 400 may have a color. For example, the protective layer 400 includes a black color.

The protective layer 400 may include metal particles. For example, the protective layer 400 may include copper particles. Accordingly, a thermal conductivity of the protective layer 400 is improved. Accordingly, heat generated in the display device can be dissipated by the protective layer 400.

Referring to FIG. 14 and FIG. 15, the shape and size of the pattern on the first region 1A and the second region 2A may be different.

Referring to FIG. 14, a first pattern P1 including a first small area hole SP1 and a first large area hole BP1 may be disposed in the first region 1A. In addition, a second pattern P2 including a second small area hole SP1 and a second large area hole BP2 may be disposed in the second region 2A.

Referring to FIG. 14, the flattening layer 200 may be folded so that it becomes a folding inner surface FIS and the protective layer 400 becomes a folding outer surface FOS. Accordingly, it may be folded into a shape as described above in FIG. 7 and FIG. 9.

Accordingly, a surface where the first large area hole BP1 is formed may be an folding inner surface, and a surface where the first small area hole SP1 is formed may be a folding outer surface. Accordingly, the compressive stress of the folding inner surface is reduced. In addition, the pattern opening is reduced by the tensile stress of the folding outer surface.

Referring to FIG. 15, a first pattern P1 including a first small area hole SP1 and a first large area hole BP1 may be disposed in the first region 1A. In addition, a second pattern P2 including a second small area hole SP1 and a second large area hole BP2 may be disposed in the second region 2A.

Referring to FIG. 15, the flattening layer 200 can be folded so that the folding inner surface FIS and the protective layer 400 can be folded so that the folding outer surface FOS. Accordingly, it can be folded into a shape as in FIG. 7 and FIG. 9 described above.

Accordingly, the surface where the first small area hole SP1 is formed of the elastic member 100 can become the folding inner surface, and the surface where the first large area hole BP1 is formed can become the folding outer surface. Accordingly, the folding of the panel on the surface where the panel is placed can be reduced. In addition, the protective layer 400 can effectively protect the elastic member on the outer folding surface.

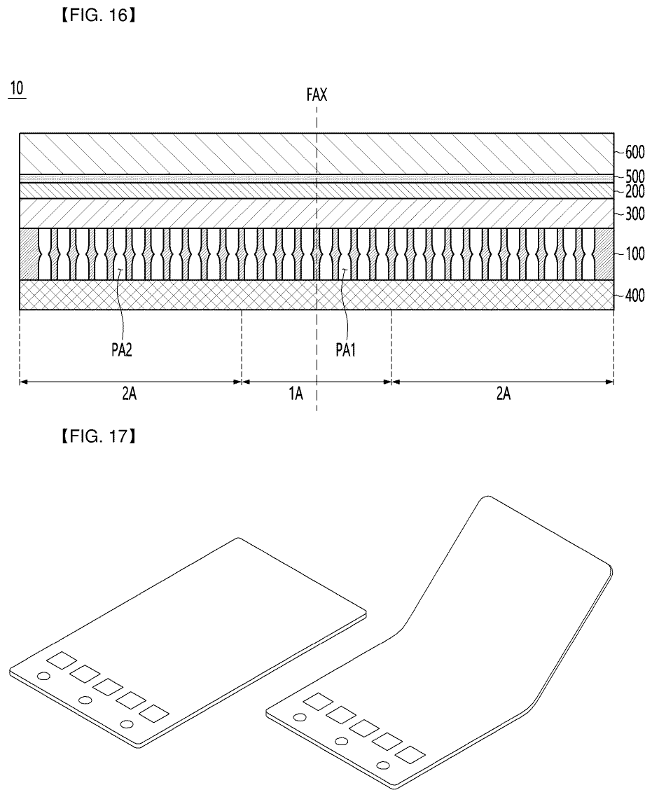

Hereinafter, referring to FIG. 16, a display device including a folding support according to the embodiment described above will be described.

Referring to FIG. 16, the display device 10 can include a folding support and a panel.

The display device 10 is disposed on the folding support and the folding support. The display device 10 may include a panel layer 600 including a display panel and/or a touch panel.

A bonding layer 500 is disposed between the elastic member 100 and the panel layer 600. The elastic member 100 and the panel layer 600 are bonded by the bonding layer 500.

Since a bonding surface of the elastic member is flattened by the flattening layer 200, the elastic member and the panel layer can be easily bonded.

FIG. 17 is a drawing for explaining an example in which the elastic member according to the embodiments is applied.

Referring to FIG. 17, the elastic member according to the embodiments may be applied to a flexible or foldable display device that displays a display.

For example, the elastic member according to the embodiments may be applied to a flexible display device such as a mobile phone or a tablet. The flexible display device can be flexible, bent or foldable.

The elastic member is applied to the display device. Accordingly, the folding reliability of the display device is improved.

The characteristics, structures and effects described in the embodiments above are included in at least one embodiment but are not limited to one embodiment. Furthermore, the characteristics, structures, and effects and the like illustrated in each of the embodiments may be combined or modified even with respect to other embodiments by those of ordinary skill in the art to which the embodiments pertain. Thus, it should be construed that contents related to such a combination and such a modification are included in the scope of the embodiment.

The above description has been focused on the embodiment, but it is merely illustrative and does not limit the embodiment. A person skilled in the art to which the embodiment pertains may appreciate that various modifications and applications not illustrated above are possible without departing from the essential features of the embodiment. For example, each component particularly represented in the embodiment may be modified and implemented. In addition, it should be construed that differences related to such changes and applications are included in the scope of the embodiment defined in the appended claims.

1. An elastic member including a first region and a second region and foldable with respect to a folding axis, the elastic member comprising:
wherein the elastic member is defined in a first direction in which the folding axis extends, and a second direction perpendicular to the first direction,
wherein the first region is divided into a first-first region, which includes the folding axis and is close to the folding axis, and a first-second region, which is farther from the folding axis than the first-first region,
wherein the first-second region is connected to both ends of the first-first region facing each other in the second direction,
wherein the first-first region includes a plurality of first pattern parts including a plurality of first patterns,
wherein the plurality of first pattern parts include a first-first pattern part including a first hinge pattern having one side open to an outside of the elastic member and a first-second pattern part not including a first hinge pattern,
wherein the first-second region includes a plurality of second pattern parts including a plurality of second patterns,
wherein the plurality of second pattern parts include a second-first pattern part including a second hinge pattern having one side open to the outside of the elastic member, and a second-second pattern part not including a second hinge pattern, and
wherein an opening rate per unit area of the first-first region and an opening rate per unit area of the first-second region are different.

2. The elastic member of claim 1, wherein a length of the first pattern decreases from the folding axis toward the first-second region, and
wherein a length of the second pattern does not change as it moves away from a boundary region of the first-first region and the first-second region.

3. The elastic member of claim 2, wherein a maximum length of the first pattern is greater than a maximum length of the second pattern, and
wherein the minimum length of the first pattern corresponds to the maximum length of the second pattern or a minimum length of the second pattern.

4. The elastic member of claim 2, wherein the opening rate per unit area of the first-first region is greater than the opening rate per unit area of the first-second region.

5. The elastic member of claim 2, wherein the first-first region is folded with a first curvature less than or equal to a first size,
wherein the first-second region is folded with a second curvature less than or equal to a second size, and
wherein the first size is greater than the second size.

6. The elastic member of claim 1, wherein a length of the first hinge pattern decreases from the folding axis toward the first-second region, and
wherein a length of the second hinge pattern does not change as it moves away from a boundary region of the first-first region and the first-second region.

7. The elastic member of claim 1, wherein a maximum length of the first hinge pattern is greater than a maximum length of the second hinge pattern, and
wherein a minimum length of the first hinge pattern corresponds to the maximum length of the second hinge pattern or a minimum length of the second hinge pattern.

8. The elastic member of claim 1, wherein a length of the first pattern increases from the folding axis toward the first-second region, and
wherein a length of the second pattern does not change as it moves away from a boundary region of the first-first region and the first-second region.

9. The elastic member of claim 8, wherein a minimum length of the first pattern is smaller than a minimum length of the second pattern, and
wherein a maximum length of the first pattern corresponds to a maximum length of the second pattern or the minimum length of the second pattern.

10. The elastic member of claim 8, wherein the opening rate per unit area of the first-second region is greater than the opening rate per unit area of the first-first region.

11. The elastic member of claim 8, wherein the first-first region is folded with a first curvature less than or equal to a first size,
wherein the first-second region is folded with a second curvature less than or equal to a second size, and
wherein the second size is greater than the first size.

12. The elastic member of claim 1, wherein a length of the first pattern decreases from the folding axis toward the first-second region, and
wherein a length of the second pattern increases as it moves away from a boundary region between the first-first region and the first-second region in the second direction.

13. The elastic member of claim 12, wherein a minimum length of the first pattern corresponds to a minimum length of the second pattern, and
wherein a maximum length of the first pattern is different from a maximum length of the second pattern.

14. The elastic member of claim 12, wherein a difference between a maximum length and a minimum length of the first pattern is different from a difference between a maximum length and a minimum length of the second pattern.

15. The elastic member of claim 1, wherein a length of the first pattern increases from the folding axis toward the first-second region, and
wherein a length of the second pattern decreases as it moves away from a boundary region between the first-first region and the first-second region in the second direction.

16. The elastic member of claim 15, wherein a maximum length of the first pattern corresponds to a maximum length of the second pattern, and
wherein a minimum length of the first pattern is different from a minimum length of the second pattern.

17. The elastic member of claim 15, wherein a difference between a maximum length and a minimum length of the first pattern is different from a difference between a maximum length and a minimum length of the second pattern.

18. A folding support comprising:
an elastic member of claim 1;
a protective layer disposed on a lower side of the elastic member; and
a flattening layer disposed on an upper side of the elastic member.

19. A display device comprising:
an elastic member of claim 1;
a protective layer disposed on a lower side of the elastic member;
a flattening layer disposed on an upper side of the elastic member;
an adhesive layer disposed on the flattening layer; and
a panel layer disposed on the adhesive layer.

20. The display device of claim 19, wherein the panel layer includes at least one panel among a display panel and a touch panel.
